(19) United States
(12) Patent Application Publication
(10) Pub. No.: US 2014/0016897 A1
(43) Pub. Date: Jan. 16, 2014

(54) Adjustable Fiber Optic Module System and Method

(71) Applicant: John David Glenn, Carlisle, MA (US)

(72) Inventor: John David Glenn, Carlisle, MA (US)

(73) Assignee: TeraDiode, Inc., Littleton, MA (US)

(21) Appl. No.: 13/587,904

(22) Filed: Aug. 16, 2012

Related U.S. Application Data
(60) Provisional application No. 61/524,058, filed on Aug. 16, 2011.

(51) Int. Cl. G02B 6/32

(52) U.S. Cl. CPC G02B 6/32
USPC 385/33

(57) ABSTRACT

A pivotal and adjustable FOM system and method for aligning incoming beams into optical fibers.

### CROSS-REFERENCE TO RELATED APPLICATIONS

This application claims priority under 35 U.S.C. §119 to the following U.S. Provisional Patent Applications, each of which is hereby incorporated by reference in its entirety: U.S. Ser. No. 61/524,058 filed Aug. 16, 2011.

### COPYRIGHT STATEMENT

A portion of the disclosure of this patent application document contains material that is subject to copyright protection including the drawings. The copyright owner has no objection to the facsimile reproduction by anyone of the patent document or the patent disclosure as it appears in the Patent and Trademark Office file or records, but otherwise reserves all copyright rights whatsoever.

### BACKGROUND OF THE INVENTION

1. Field of the Invention

The present embodiments relate generally to adjustable fiber optic modules.

2. Description of the Prior Art

Traditionally, when coupling beams into fibers using current Fiber optical Modules (FOMs), the fiber and the laser have usually been only approximately parallel and centered and the optical lens used therein is displaced laterally to compensate for those errors.

However it is desired when coupling or sending a beam or plurality of beams into a fiber, to have the fiber, the optical lens, and the light beam all co-axial, and to have the fiber at the focal point of the lens.

The following application seeks to solve the problems stated.

### SUMMARY OF THE INVENTION

A fiber-optic module (FOM) apparatus comprising a fixed mount having a cavity with at least one opening; an inner housing placed within the cavity and attached to the fixed mount by an annular flexure, wherein the inner housing is configured to co-axially align to an optical fiber and an optical element placed therein within 0.001 of an inch, and wherein the annular flexure allows the inner housing to be positionable within the fixed mount, thus allowing for a non-normal incident beam entering said FOM to be coaxially aligned with the optical element and optical fiber.

### BRIEF DESCRIPTION OF THE DRAWINGS

FIG. 1A illustrates a partial view of and adjustable FOM aligned to receive a beam at a normal incidence angle.

FIG. 1B illustrates a partial view of and adjustable FOM aligned to receive a beam at a non-normal incidence angle.

### DETAILED DESCRIPTION OF THE PREFERRED EMBODIMENT

Aspects and embodiments relate generally to the field of coupling laser beams into fiber optical cables.

Embodiments described herein include addressing coaxially aligning an incoming beam with an optical focusing element and an optical fiber positioned to receive the incoming beam.

The approaches and embodiments described herein may apply to single and multi-wavelength beams, such as those produce by wavelength beam combining (WBC) systems.

For purposes of this application optical elements may refer to any of lenses, mirrors, prisms and the like which redirect, reflect, bend, or in any other manner optically manipulate electromagnetic radiation. Additionally, the term beam includes visible light, infrared radiation, ultra-violet radiation, and electromagnetic radiation.

The embodiments and designs described herein are unique in their ability to achieve the ideal co-axiality alignment of fiber, lens(es), and light beam to precision machining tolerances (0.001″). Such alignment helps to all reduce the effects of aberrations of the lens(es) due to off-axis alignment. Furthermore, the optical lenses used in the adjustable FOMs described herein can have lower tolerances for aberrations because of this coaxial alignment of the incoming beam, lens(es) and optical fiber.

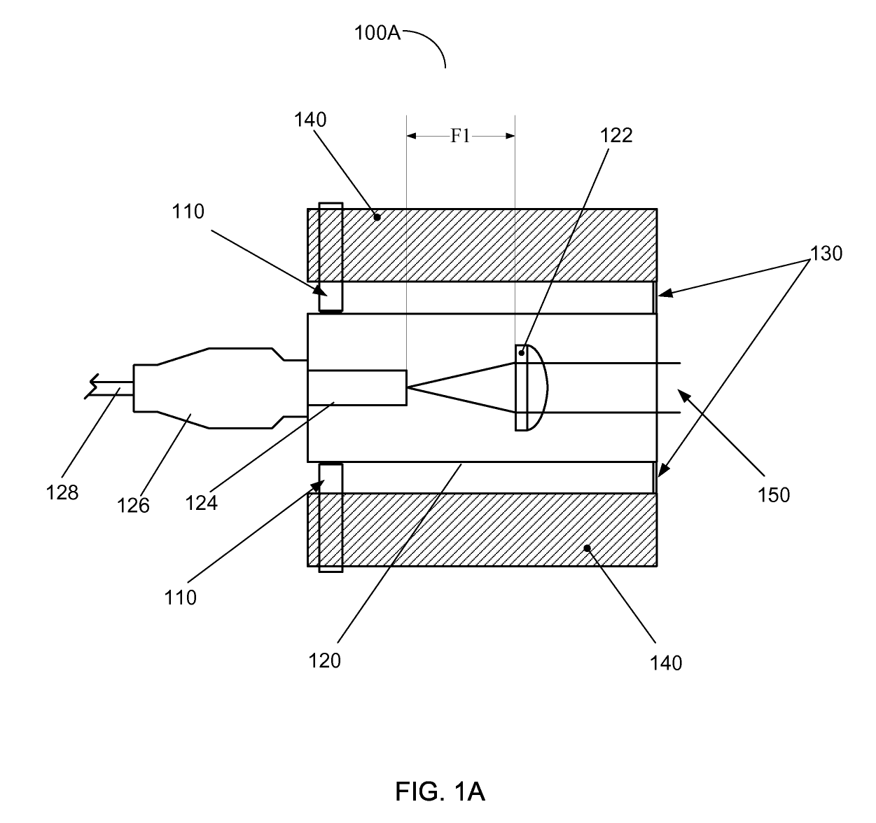

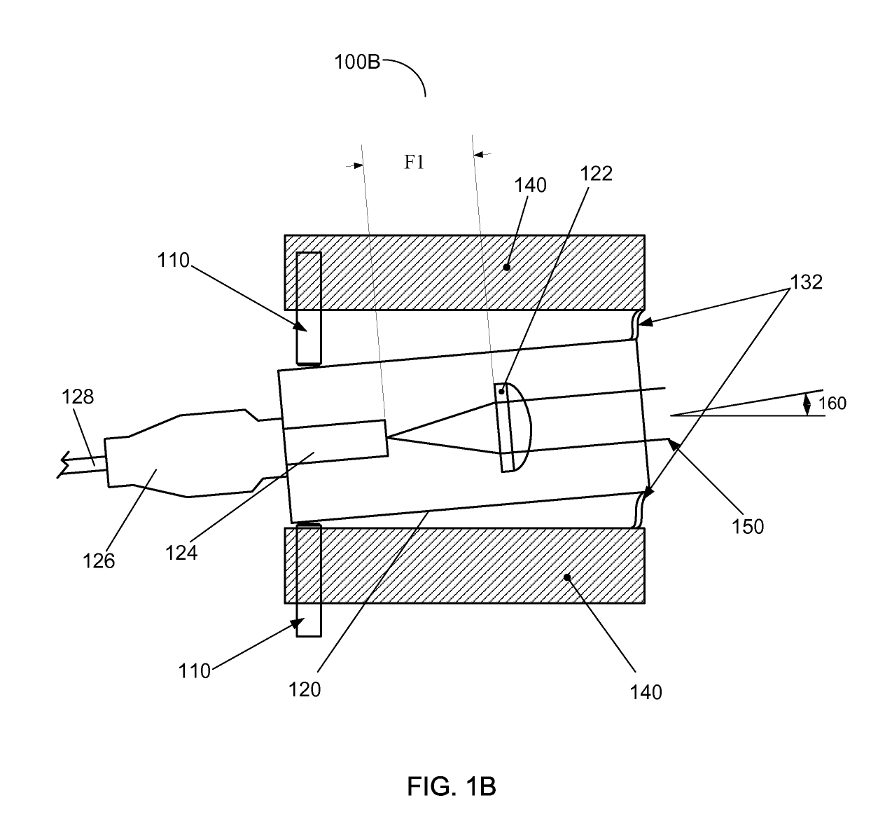

A partial cut-out view of an adjustable FOM 100A is illustrated in FIG. 1A. A fixed mount 140 or outer body has a cavity portion within it that contains the fiber and lens mount 120 or inner housing. The fiber and lens 120 is configured to have an optical fiber 124 inserted into one end of the inner housing 120 as well as an optical element 122. This inner housing 122 may be machined to tolerances of approximately .001 inches. The position of the end of the optical fiber 124 can be laterally adjusted with respect to the optical element 122 such that the end of the optical fiber 124 is placed within the focal length (F1) of optical element 122. On the optical element end of the fiber and lens mount 120 an aperture allows for an incoming beam 150 to enter into the inner housing 120 of the FOM 100A, be focused by optical element 122 into the optical fiber 124 where the incoming beam 150, optical element 122 and optical fiber 124 or coaxially or substantially coaxially aligned along the same optical beam path. This inner housing/mount 120 is movably attached and pivotal to the fixed mount 140 portion of the FOM 100A by an annular flexure(s) 130 on one end of the fixed mount. Away from the annular flexure in this embodiment, adjustment screws 110 extend from the fixed mount to secure the other end of the inner housing 120 from moving. These adjustment screws allow for a fine tuning of the angle (tip and tilt) of the inner housing 120 with respect to the fixed mount 140.

Using adjustment screws at the end of the monolithic fiber & lens mount 140 opposite the annular flexure, if that mount is longer than the focal length of the lens(es) 122 by a factor of N then this design gives a desirable de-magnification of adjustment sensitivity. For example, if the lens focal length is 15 mm and the monolithic fiber/lens mount is 60 mm long, then to move the focused spot on the face of the fiber by 1 micron the adjustment screws must be adjusted by 60/15=4 microns.

Unlike traditional X-Y stages carrying the lens(es), using an annular flexure tip-tilt mechanism has several clear advantages:

This design can easily give an air-tight seal which is very desirable for high-power lasers, as the annular flexure completely surrounds the entrance aperture of the FOM for incoming beams. The naturally friction-free aspect of flexures gives a naturally smooth adjustment, thus providing for ease of adjustment.

The flexure is much more compact than traditional X-Y stages using balls and springs and the flexure is extremely rugged and insensitive to vibration and jarring.

As mentioned, the function of an FOM is to allow an optical fiber, a focusing lens (or lenses), and a beam of light (usually a collimated laser beam) to be co-aligned so as to place the focused beam of light at best focus centered on the fiber. The ideal configuration, of course, is to have the fiber, the lens, and the light beam all co-axial, and to have the fiber at the focal point of the lens. Traditionally, however, this has not been the case in FOMs; instead, the fiber and the laser have usually been only approximately parallel and centered and the lens has been displaced laterally to compensate for those errors. The FOM of the present application, in contrast, achieves the ideal coaxial alignment of the three components within very precise machining tolerances on the order of one thousandth of an inch and within a fraction of a milliradian in angle. This is achieved by building a monolithic precision machined mount for the fiber and lens (or lenses) allowing only for a focus adjustment of the separation between the fiber and the lens(es), and ensuring co-axiality of fiber and lens(es) to precision machining tolerances of a 0.001″ or more. Assuming co-axiality of the fiber and lens(es) any ray of light parallel to that axis will focus to the center of the fiber (assuming a perfect lens or lenses). All that is required, therefore, to focus the light beam onto the center of the fiber is to allow for tipping and tilting of the fiber/lens(es) assembly with respect to the laser beam. As discussed, the FOM embodiments described herein accomplish this in a novel way by means of an annular flexure which rigidly constrains centering of the assembly but allows tip & tilt adjustments in a smooth friction-free way.

The FOM 100B as illustrated in FIG. 1B, shows an FOM 100B embodiment in a tilted position/angle 160 with respect to the incoming beam 150. The annular flexures 132 shown are distorted when tilting of the inner housing 120 occurs. In reality this distortion is often slight, but is drawn in an over exaggerated manner to illustrate the functionality of the FOM 100B. As can also be seen one of the adjustment screws 110 extends further into the cavity portion of the fixed mount pressing up against the inner housing 120, while the other adjustment screw illustrated extend further out of the fixed mount 140. The fiber housing end 126 and optical cable 128 pivot with the inner housing (fiber and lens mount) 120.

In additional embodiments the flexure supporting the inner housing and allowing it to pivot about fixed mount may be comprised of a plurality of individual flexures and not completely annular. The flexures described herein may be made of any deformable material that allows it retain its original position including various metallic, synthetic and other deformable materials.

It should be noted the optical fiber and optical elements placed within the inner housing or fiber and lens mount may be permanently fixed into place using an epoxy. In some configurations the elements are pressure fit into there respective cavities formed within the inner housing. These cavities may be machined or formed via high tolerance mold applications. In some instances the inner housing may be comprised of a plurality of components such as two halves. This high tolerance machining or forming of the inner housing allows for the tight coaxial alignment of the inserted fiber and optical element.

The above description is merely illustrative. Having thus described several aspects of at least one embodiment of this invention including the preferred embodiments, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A fiber-optic module (FOM) apparatus comprising:
a fixed mount having a cavity with at least one opening;
an inner housing placed within the cavity and attached to the fixed mount by an annular flexure,
wherein the inner housing is configured to co-axially align an optical fiber and an optical element placed therein within a thousandth of an inch, and
wherein the annular flexure allows the inner housing to be positionable within the fixed mount.

2. The apparatus of claim 1, wherein the fixed mount further includes adjustment screws positioned and configured to tilt or tip the inner housing about the annular flexure.

3. The apparatus of claim 1, wherein the positioning of the inner housing does not cause permanent deformation to the annular flexure.

4. The apparatus of claim 2, wherein the adjustment screws are positioned at a length away from the annular flexure greater than the focal length of the optical element placed in the inner housing.

5. A method for aligning a beam into an optical fiber comprising the steps of:
co-axially aligning the end of an optical fiber to an optical lens in an inner housing;
positioning the end of the optical fiber within a focal length of the optical lens within the inner housing, wherein the inner housing has an aperture for receiving a beam; and
pivoting the inner housing about a fixed mount by means of an annular flexure.

6. The method of claim 6, further including adjusting the position of the inner housing by alignment means.

7. The method of claim 7, wherein the alignment means include adjustment screws protruding from a fixed mount, and wherein the adjustment screws abut against the external surface of the inner housing.
